(19) United States
(12) Patent Application Publication
(10) Pub. No.: US 2012/0131646 A1
(43) Pub. Date: May 24, 2012

(54) ROLE-BASED ACCESS CONTROL LIMITED BY APPLICATION AND HOSTNAME

(75) Inventors: Uma M. Chandolu, Bangalore (IN); Jyoti B. Tenginakai, Gadag (IN); Ranganathan Vidya, Bangalore (IN)

(73) Assignee: INTERNATIONAL BUSINESS MACHINES CORPORATION, Armonk, NY (US)

(21) Appl. No.: 12/951,134

(22) Filed: Nov. 22, 2010

(51) Int. Cl. G06F 21/00

(52) U.S. Cl. 726/4

(57) ABSTRACT

In a Role Based Access Control (RBAC) system, an additional layer of access control is provided on a per-client basis on a centralized directory or database server. Access to privileged commands that are otherwise accessible by a user under a given role may be restricted by the additional layer of access control, depending on the client under which access is attempted. Thus, a user otherwise authorized to access a privileged command under an assigned role using one client may be restricted from accessing that command from a particular client system, even if another user having the same role is allowed to access that command using another client.

BACKGROUND

1. Field of the Invention

The present invention relates to access control in a computer system, and more particularly to role-based access control.

2. Background of the Related Art

Role Based Access Control (RBAC) is an approach to computer system security wherein the permissions or authorizations to perform specific operations are granted to users based on assigned roles. In RBAC, different roles are created, each of which can be associated with a different set of authorizations. Different roles are selectively assigned to users, such that each user obtains authorizations according to one or more roles assigned to that user. RBAC can be applied to an organization, for example, wherein different job functions require access to different system commands or applications. Roles are typically defined according to the scope of managing one or more administrative aspects of the environment. For example, one management role might be to manage the file systems, while another role might be to enable the creation of user accounts.

RBAC offers a number of features not offered in other forms of system administration. One benefit of RBAC is that system administration responsibilities can be shared among users without sharing system access credentials among those users. Security is isolated through granular administration, such that each administrator is conferred only the necessary set of privileges. Granting users and applications a limited set of privileges reduces the likelihood or severity of a system attack. RBAC also allows for implementing and enforcing company-wide security policies consistently in regard to system management and access control. RBAC is flexible, providing a role definition that can be created once, and then selectively assigned or withdrawn from users on an as-needed basis, such as when a user changes job functions.

### BRIEF SUMMARY

One embodiment provides a Role Based Access Control (RBAC) system including a privileged command database, a privileged client database, and an access control module in communication with the privileged command database and the privileged client database. The privileged command database associates one or more privileged commands with one or more user-assignable roles, such that each role authorizes access to a different subset of privileged commands. The privileged client database restricts access to specified privileged commands from specified client systems under specified roles. The access control module provides a user access to a selected privileged command from a selected client system if the user has an assigned role authorizing access to the selected privileged command according to the privileged command database and if access to the selected privileged command from the selected client system is authorized under the assigned role according to the privileged client database.

Another embodiment provides a method for controlling access in an RBAC system. A plurality of roles are defined, wherein each role authorizes access to a different subset of privileged, computer-executable commands. The roles are selectively assigned to users. Access to specified privileged commands are selectively restricted on specified client systems according to specified roles. A user is allowed to access a selected privileged command from a selected client system only if the user has an assigned role authorizing access to the selected privileged command and if access to the selected privileged command from the selected client system is authorized under the assigned role.

In a computer-implemented embodiment, the method may be implemented using a computer program product including computer usable program code embodied on a computer usable storage medium.

### BRIEF DESCRIPTION OF THE SEVERAL VIEWS OF THE DRAWINGS

FIG. 1 is a schematic diagram of a security repository for an RBAC system providing an additional layer of client-specific access control that may be combined with existing, role-based access control functionality.

FIG. 2 is a schematic diagram further illustrating the associations between users, roles, and authorizations.

FIG. 3 is another schematic diagram illustrating the bundle of authorizations 16 and associated privileges according to role.

FIG. 4 is an example format for a directory entry from the PrivClient database of FIG. 1.

FIG. 5 is the directory entry of FIG. 4 with example attribute values applied.

FIG. 6 provides an additional example format for the PrivClient database according to another embodiment of the invention.

FIG. 7 is the directory entry of FIG. 6 with example attribute values applied.

FIG. 8 is a diagram of an example implementation of role-based access control with per-client restrictions in a centralized, heterogeneous environment.

### DETAILED DESCRIPTION

Embodiments of the present invention include a Role-Based Access Control (RBAC) system and method in which an additional, client-specific layer of access control may be imposed. One embodiment disclosed herein provides an LDAP (Lightweight Directory Access Protocol) subsystem configured with several different client systems (i.e. clients) in a centralized, heterogeneous environment. A centralized database contains privileged applications and commands. The privileged applications and commands are associated with different roles, so that a particular command or application may be accessed by one of the clients only by a user having an associated role authorizing the user to do so. The user may attempt to access a privileged command in the centralized database from any of the clients.

In a conventional RBAC system, a user would get the same privileges to perform system management functions in all LDAP client systems. However, the additional, client-specific layer of access control further limits which privileged applications and commands may be accessed according to both user and hostname of the client system. Thus, a given user may be restricted from accessing a privileged command from a specific client system, even if the given user has an assigned role otherwise authorizing the user to access the privileged command. The role-based access control and the additional client-specific limitations on the role-based access control disclosed herein are in addition to any conventional access restrictions that require a user to login using a username/password combination. However, logging in to a system is one of the mechanisms described below by which the system may determine what role(s) are assigned to the current user. That is, login credentials supplied by a user may be associated with the one or more roles assigned to that user.

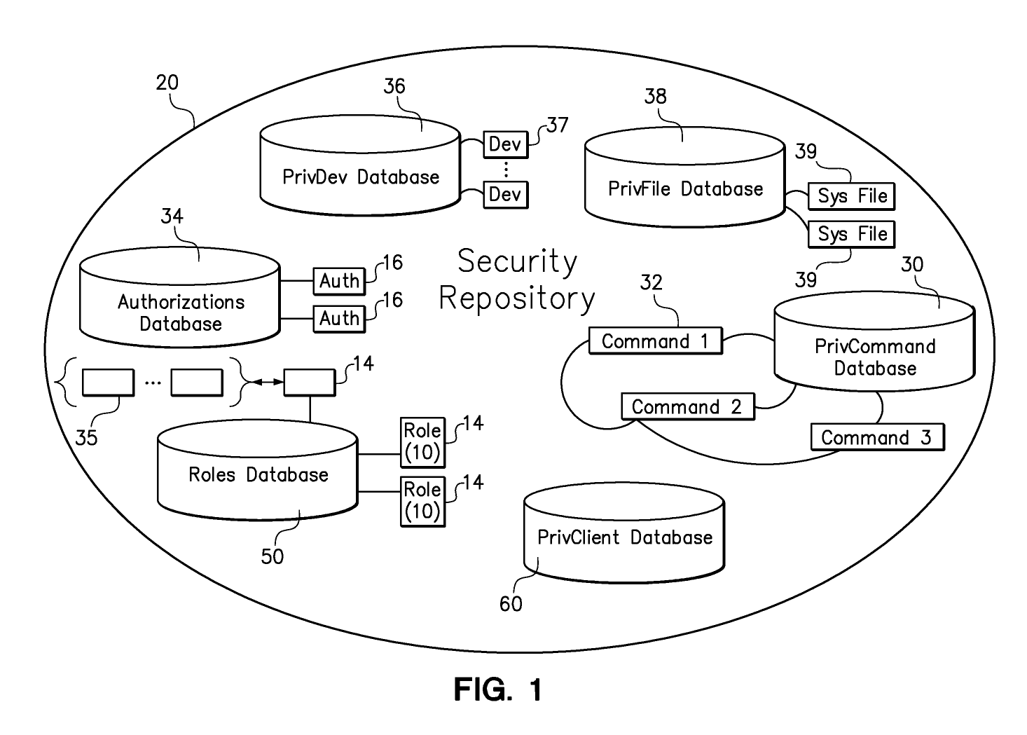

FIG. 1 is a schematic diagram of a security repository 20 for an RBAC system according to an embodiment of the invention, providing an additional layer of client-specific access control that may be combined with existing, role-based access control functionality. The security repository 20 contains some entities that may have analogous counterparts in some existing RBAC systems, including a Privileged Command (“PrivCommand”) database 30, an Authorization database 34, a Privileged Device (“PrivDev”) database 36, a Privileged File (“PrivFile”) database 38, and a Roles database 50, that support existing RBAC functionality. The security repository 20 further includes Privileged Client (“PrivClient”) database 60 in accordance with embodiment of the invention that support the additional, client-specific access control layer. The number of databases in the repository 20 is unlimited, and is not necessarily limited to the databases shown. The various databases included in the repository 20 may be distributed at different geographical locations accessible over a network, or may be combined in a single location as a centralized collection of databases.

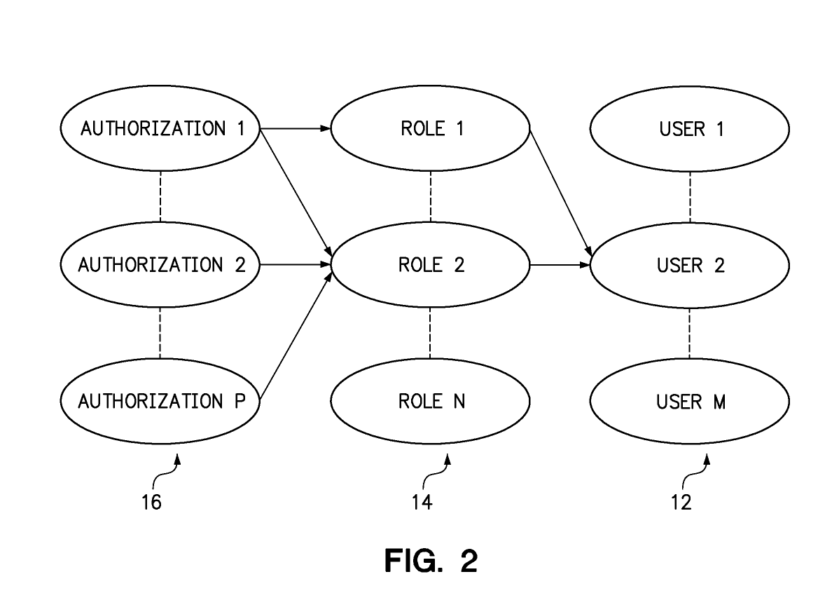

The Roles database 50 contains a plurality of roles 14 each identified by a unique role identifier (ID). The Authorization database 34 has a listing of authorizations 16, each of which may also be identified by a unique identifier. The Roles database 50 associates each role 14 with a set of one or more of the authorizations 16. The roles may be mapped to associated authorizations and assigned to users as further discussed in relation to FIG. 2. The PrivCommand database 30 contains privileged commands 32 selectively authorized for access according to authorizations and privilege mapping. Associations between authorizations or roles and privileged commands are defined in the PrivCommand database 30. Commands outside of the PrivCommand database 30 are essentially non-privileged and may be used by any user. The PrivDev databases 36 contains a list of devices 37 with read and write privileges associated with each of the privileged device. The PrivFile database 38 has a set of system files 39 that is authorized for read and write. The roles 14 from the Roles database 50 are selectively assigned to users. Together, the Roles database 50 and the PrivCommand database 30 provide a basis for limiting access on a per-role basis to users.

The new PrivClient database 60 provided in the present embodiment of the invention adds another layer of access control to traditional RBAC functionality. The PrivClient database 60 additionally restricts access on a per-client basis according to defined relationships between users, privileged commands, and client systems (i.e. “clients”). In particular, the PrivClient database 60 is provided to selectively restrict users having certain roles from performing certain commands from certain client systems, even when a role assigned to a user would otherwise permit access to those commands by that user.

The PrivClient database 60 is particularly useful in a centralized environment wherein multiple client systems may access the centralized database 20. The PrivClient database 60 may not have any entries on a local host. Updates to the PrivClient database 60 on a centralized directory server may be made with an application which can be invoked from a client, as controlled and selectively restricted according to inputs relating to users, client information, and a privileged commands listing.

The security repository 20 may reside in the local file system. Alternatively, the security repository 20 may be managed remotely through a suitable application protocol in a centralized location, such as a centralized database or directory server. For example, Lightweight Directory Access Protocol (LDAP) is an application protocol for querying and modifying data of directory-based services implemented in Internet Protocol (IP) networks. LDAP can be used to efficiently create, modify, and access such directories and databases. User management is an important part of distributed computing environments. It provides the consistent authentication and authorization services necessary for universal access. For centralized security, an LDAP protocol is widely used for authentication and retrieving the user data on Directory server. Organizations typically store data in multiple, heterogeneous databases. In a heterogeneous environment, different types of LDAP Servers can be configured to maintain user data on servers. According to this model, each application on an LDAP client system will go through the LDAP client daemon to retrieve information from the LDAP server.

FIG. 2 is a schematic diagram further illustrating the associations between users 12, roles 14, and authorizations 16. An RBAC system may support any number of “M” users 12, from User 1 to User M. Any number of “N” roles 14 may also be created, from Role 1 to Role N. Any number “P” of authorizations 16 may be defined, from Authorization 1 to Authorization P. Each role 14 is associated with a different set of authorizations 16. An authorization 16 may be a text string in a dot format of hierarchical order which defines the role. These text strings give a logical representation to an authorization level in the RBAC environment to associate each authorization 16 with one or more privileged commands 32.

The mapping provided by the schematic diagram of FIG. 2 provides an example of associations between users 12 and roles 14 and between roles 14 and authorizations 16. In this example, User 2 has two associated roles shown, namely, Role 1 and Role 2. Role 1 is associated with Authorization 1. Role 2 is associated with three of the authorizations shown, namely, Authorizations 1, 2, and P. Role N is not associated with any of the authorizations 16 nor assigned to any of the users shown in FIG. 2. However, Role N may be associated with other authorizations and may be assigned to other users not expressly shown in FIG. 2, as any number of authorizations 16 and any number of users 12 may be supported in a RBAC system.

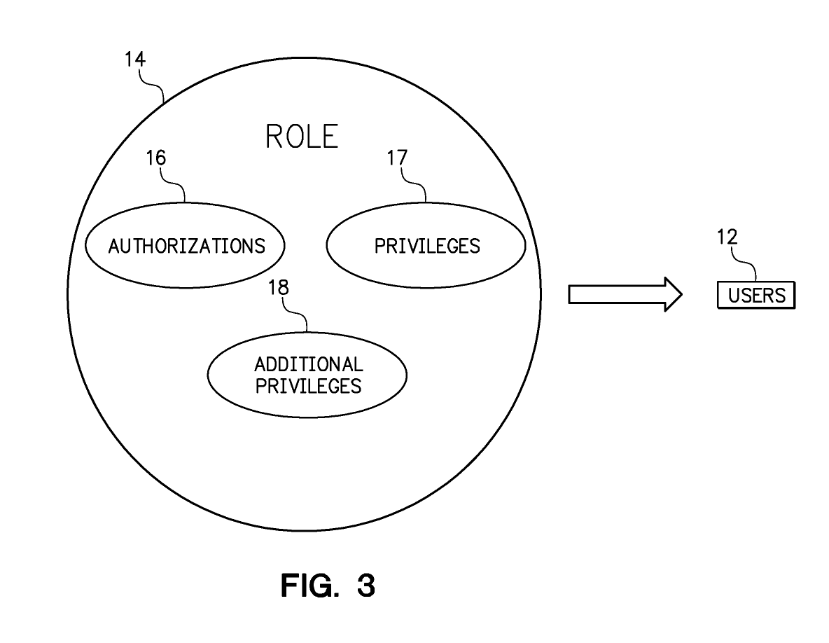

FIG. 3 is another schematic diagram illustrating the bundle of authorizations 16 and associated privileges 17 according to a particular role 14. Additional privileges 18 are optionally provided, which may not be available for every user. You can retain the same. No need to extend further on it. When a user 12 attempts to access or execute a selected privileged command 32 that is listed in the PrivCommand database 30 (see FIG. 1), access to the selected privileged command 32 is granted only if the invoking user 12 has the required authorization 16 under the one or more role 14 assigned to the user 12. Roles 14 and authorizations 16 can be created by users such as a “root” user, to enable the ability of the root user to access privileged commands. By contrast, privileges 17 are the restriction mechanism used in the kernel of an operating system as bit-mask values to determine if a process is allowed to perform a particular action. Privileges 17 are part of the RBAC infrastructure that provides fine granular control of system functions. A privilege 17 is a process attribute that provides trusted applications with capabilities that are not permitted to untrusted applications. For example, privileges 17 can be used to override security constraints, to permit the expanded use of certain system resources such as memory and disk space, and to adjust the performance and priority of a process. A privilege 17 can be thought of as an ability that allows a process to overcome a specific security constraint in the system. Privileges 17 are associated with a process and are typically acquired through the invocation of a privileged command 32 (FIG. 1). Because of these associated privileges, the process is eligible to perform the related privileged operation. For example, if a user 12 has a role 14 with an authorization to run a privileged command, a set of privileges is assigned to that process when the privileged command is run.

In one example, a set of applications or commands may be installed on a system as part of package bundle. A hypothetical role of “ArchiveManager” is created that includes privileges to access “backup” and “restore” commands included with the package bundle. A PrivClient database may place certain client-specific restrictions on the role “ArchiveManager” that are invoked according to the particular client a user is using when attempting to access the commands. For example, a user having the role ArchiveManager may be restricted from using the restore command on Client1, even though that command is generally authorized under the role of ArchiveManager. This client-specific restriction to role-based privileges is defined herein as client isolation.

In another example, two users may be assigned the same roles that each authorize access to a privileged command ABC, and yet one of those two users may still be prevented from accessing command ABC by virtue of client-specific restrictions. Although each user has the same assigned roles authorizing the same privileged commands, each user is accessing the command from a different client, one of which restricts the use of that command.

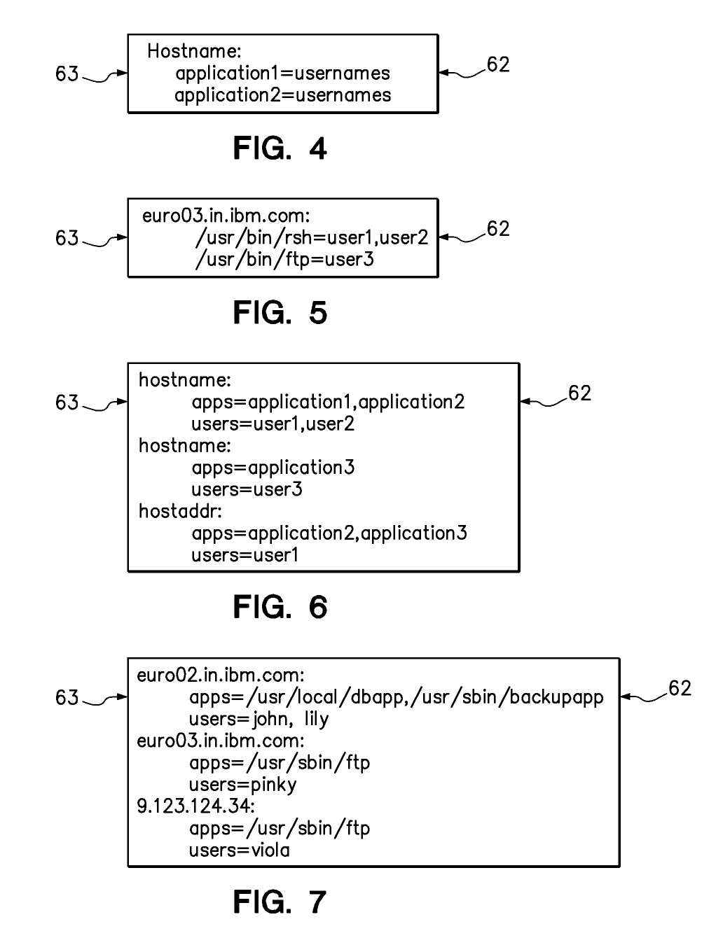

FIG. 4 is an example format for a directory entry 62 from the PrivClient database 60 of FIG. 1. Whereas a directory is a set of objects with attributes organized logically in a hierarchical manner, a directory entry consists of a set of attributes. The directory entry 62 is represented here as it may appear in LDAP Data Interchange Format (LDIF), since LDAP, itself, is a binary protocol. A separate directory entry 62 may exist for each client system (i.e. client). The directory entry 62 provides restrictions on a set of applications for a particular LDAP client based on username. The directory entry 62 uniquely identifies the LDAP client by a hostname 63. The hostname 63 can be expressed in the form of an IP address. For the particular client designated by hostname 63, the PrivClient directory entry 62 limits a first application (application 1) to a particular set of usernames, and a second application (application 2) to another particular set of usernames.

FIG. 5 is the directory entry 62 of FIG. 4 with example attribute values applied. An LDAP server may be configured for use by any number of users, including members “user1,” “user2,” and “user3”. The LDAP server may be configured for access by any number of client systems (i.e. clients), including one client whose host name is represented in the directory entry 62 by IP address “euro3.in.ibm.com.” The directory entry 62 places certain restrictions on which users may access the applications “rsh”, and “ftp” (file transfer protocol) from the client at euro3.in.ibm.com. In particular, access to application “rsh” from euro3.in.ibm.com is limited to user1 and user2. Access to application “ftp” from euro3.in.ibm.com is limited to user3.

FIG. 6 provides an additional example format for the PrivClient database 60 according to another embodiment of the invention. An LDAP server may be configured for use by any number of users, including members “user1,” “user2,” and “user3.” The directory entry 62 uniquely identifies the LDAP client by a hostname 63. The hostname 63 can be expressed in the form of an IP address. For the particular client designated by hostname 63, the PrivClient directory entry 62 limits application1 and application2 to user1 and user2, and limits application3 to user3. FIG. 7 is the directory entry 62 of FIG. 6 with example attribute values applied.

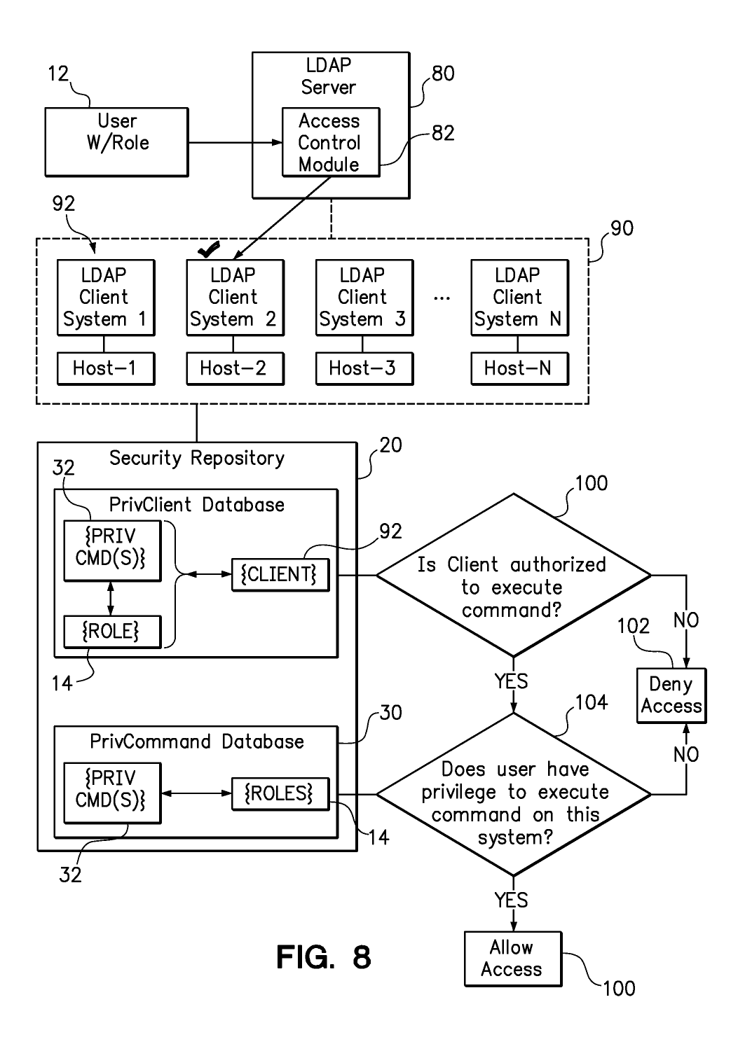

FIG. 8 is a diagram of an example implementation of role-based access control with per-client restrictions in a centralized, heterogeneous environment. The heterogeneous environment is an environment in which selected user-access is granted to applications on different systems running on different platforms. However, the invention may be applied to either a homogeneous or heterogeneous environment. An LDAP subsystem 90 is configured with a number “N” of LDAP clients 90 for querying and modifying data of directory-based services implemented in Internet Protocol (IP) networks. The clients 92 of the LDAP subsystem 90 are each in electronic communication with the security repository 20, such as over a network.

The security repository 20, as discussed above, includes the PrivCommand database 30, which defines relationships between one or more roles or authorizations 14 and the different privileged commands 32 authorized in association with each role 14. The PrivClient database defines, for each client, one or more of the roles restricted from accessing certain privileged commands 32 that would otherwise be authorized for access by a user under that role 14.

Client-specific access restrictions may be defined explicitly or implicitly. For example, a user having a particular role may be explicitly prevented from accessing a particular command from a selected client 92S when access to that particular command is otherwise authorized under the particular role. Alternatively, a user having a particular role may be implicitly restricted from accessing a particular application from the selected client 92S unless access to that particular application is specifically authorized. These client-specific restrictions may be defined, for example, according to one of the directory entries 62 of FIG. 4 or 5.

In this example, the user 12 starts an LDAP session on the selected LDAP client 92S by connecting to the LDAP server 80. The LDAP server 80 includes an access control module 82 that the user 12 may interface with, and which is directly or indirectly in communication with the security repository 20. The user 12 may enter login credentials, wherein the login credentials identify the user 12. The login credentials (e.g. username and password combination) of the user 12 may be associated with the one or more roles assigned to that user 12, such that the roles may be determined after the user 12 successfully logs in. Having logged in, the user 12 may attempt to access a selected privileged command using the selected system 92S. The selected system 92S will contact the security repository to validate the user to perform the requested command according to the role(s) of the user and identity (e.g. host name) of the selected LDAP client system 92S.

A flowchart is included in FIG. 8 to outline this validation according to user and client system identity. Conditional step 100 is to determine whether a user having the assigned role(s) is either affirmatively authorized to access, or is affirmatively restricted from accessing, the selected command on the requesting client. If the user is authorized for execution on the client according to any of the user's assigned roles to perform the selected command, then conditional step 104 is next performed otherwise denied to step 102. Conditional step 104 is to determine whether the user is authorized, under any of the user's assigned roles, to perform the selected command. If the user is not authorized according to any of the user's assigned roles to access (and thereby perform) the selected command, access is then denied according to step 102. For example, in FIG. 5, “user3” was affirmatively authorized to access ftp from the client system euro3.in.ibm.com. The determination is made according to conditional step 104 whether or not the user may access the selected command on the selected LDAP client system 92S. If so, access is allowed according to step 106. If not, access is denied according to step 102.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A Role Based Access Control (RBAC) system comprising:
a privileged command database associating one or more privileged commands with one or more user-assignable roles, wherein each role authorizes access to a different subset of privileged commands;
a privileged client database restricting access to specified privileged commands from specified client systems under specified roles; and
an access control module providing a user access to a selected privileged command from a selected client system if the user has an assigned role authorizing access to the selected privileged command according to the privileged command database and if access to the selected privileged command from the selected client system is authorized under the assigned role according to the privileged client database.

2. The RBAC system of claim 1, wherein the privileged client database defines access restrictions to the specified privileged commands according to a hostname uniquely associated with each client system.

3. The RBAC system of claim 2, wherein each host name comprises an IP address of the associated client system.

4. The RBAC system of claim 2, wherein the selected privileged command is associated with a range of hostnames and the access control module is configured to allow the selected client system to access the selected privileged command if the hostname of the selected client system is within the range of IP addresses associated with the selected privileged command.

5. The RBAC system of claim 1, wherein the privileged client database is modifiable only by a user having an assigned administrator role.

6. The RBAC system of claim 1, wherein the client systems comprise Lightweight Directory Access Protocol (LDAP) client systems.

7. The RBAC system of claim 6, further comprising:
an LDAP server in communication with the LDAP client systems, wherein the LDAP server provides user-access to each of the LDAP client systems.

8. The RBAC system of claim 1, wherein the privileged client database includes a directory entry associated with each client system, wherein each directory entry identifies which of the privileged commands each role may access on the associated client system.

9. The RBAC system of claim 8, wherein each directory entry identifies the associated client system by hostname.

10. The RBAC system of claim 1, wherein the client systems are provided in a centralized environment.

11. The RBAC system of claim 1, wherein the client systems are provided in a heterogeneous environment.

12. A method for controlling access in a Role-Based Access Control (RBAC) system, the method comprising:
defining a plurality of roles, wherein each role authorizes access to a different subset of privileged, computer-executable commands;
selectively assigning the roles to users;
selectively restricting access to specified privileged commands on specified client systems under specified roles; and
allowing a user to access a selected privileged command from a selected client system only if the user has an assigned role authorizing access to the selected privileged command and if access to the selected privileged command from the selected client system is authorized under the assigned role.

13. The method of claim 12, further comprising:
identifying the specified client systems by host name.

14. The method of claim 13, wherein each host name comprises an IP address of the associated client system.

15. A computer program product including computer usable program code embodied on a computer usable storage medium, the computer program product comprising:
computer usable program code for defining a plurality of roles, wherein each role authorizes access to a different subset of privileged, computer-executable commands;
computer usable program code for selectively assigning the roles to users;
computer usable program code for selectively restricting access to specified privileged commands on specified client systems under specified roles; and
computer usable program code for allowing a user to access a selected privileged command from a selected client system only if the user has an assigned role authorizing access to the selected privileged command and if access to the selected privileged command from the selected client system is authorized under the assigned role.

16. The computer program product of claim 15, further comprising:
computer usable program code for identifying the specified client systems by host name.

17. The computer program product of claim 16, wherein each host name comprises an IP address of the associated client system.

18. The computer program product of claim 15, wherein the computer usable program code for selectively restricting access to specified privileged commands on specified client systems under specified roles comprises a privileged client database defining access restrictions to the specified privileged commands depending on the role of a user attempting to access the specified privileged commands and the specified client systems from which the user attempts to access to access the specified privileged commands.

19. The computer program product of claim 18, further comprising:
computer usable program code for accessing the privileged client database according to a Lightweight Directory Access Protocol (LDAP).

20. The computer program product of claim 19, further comprising:
computer usable program code for communicating between an LDAP server and one or more LDAP client systems;
computer usable program code for providing selective user-access to the LDAP server from each of the LDAP client systems; and
computer usable program code for communicating between the LDAP client systems and a security repository containing the privileged client database.
